(19) United States
(12) Patent Application Publication
(10) Pub. No.: US 2025/0068999 A1
(43) Pub. Date: Feb. 27, 2025

(54) OPTIMIZATION OF CLEANING FLEET BY CAPTURING REAL-TIME SOIL LOSS INFORMATION FROM PHOTOVOLTAIC PANELS

(71) Applicant: International Business Machines Corporation, Armonk, NY (US)

(72) Inventors: Raghu Ramaswamy, Bangalore (IN); Jignesh Karia, Thane (IN); Prasanna Jirafe, Pune (IN); Priyanka Urvilsinh Rathod, Dhule (IN); Supriya Jena, Bangalore (IN); Shiva G, Bangalore (IN)

(21) Appl. No.: 18/452,998

(22) Filed: Aug. 21, 2023

(51) Int. Cl. G06Q 10/0631; H02S 50/00

(52) U.S. Cl. CPC G06Q 10/063116; H02S 50/00; H02S 40/10

(57) ABSTRACT

One embodiment provides a method including dynamically measuring, by a computing device, dust level representing decay in transistor current output by utilizing at least one particle deposition (PD) detection sensor that utilizes machine learning (ML) for condition based photovoltaic (PV) panel cleaning. An ML-based edge process is utilized for managing a cleaning schedule and cleaning fleets. Yield is boosted and dynamic planning is improved based on multiple input sources for the ML-based edge process.

### BACKGROUND

The field of embodiments of the present invention relates to using machine learning for optimizing management and scheduling of cleaning photovoltaic (PV) panels.

PV panel soiling is typically caused by the deposition and accumulation of airborne particles. Power loss associated with such a factor is known as soiling loss. Energy loss due to soiling (generally between 3 to 5%) is considered while designing the power plant. However, an observable loss may be as high as 10-12% while in operation. To improve yield, the cleaning of a solar module is important. However, it is necessary to understand exact cleaning cycle time to improve the operational efficiency. Current solutions include a periodic cleaning based on a fixed formula regarding climatic conditions. These conventional formulas are targeted to large geographic areas rather than specific areas where a solar plant is constructed, or as to whether the cleaning is really required or not.

### SUMMARY

Embodiments relate to machine learning (ML) for optimizing management and scheduling of cleaning photovoltaic (PV) panels. One embodiment provides a method including dynamically measuring, by a computing device, dust level representing decay in transistor current output by utilizing at least one particle deposition (PD) detection sensor that utilizes ML for condition based PV panel cleaning. An ML-based edge process is utilized for managing a cleaning schedule and cleaning fleets. Yield is boosted and dynamic planning is improved based on multiple input sources for the ML-based edge process.

These and other features, aspects and advantages of the present embodiments will become understood with reference to the following description, appended claims and accompanying figures.

### BRIEF DESCRIPTION OF THE DRAWINGS

FIG. 1 illustrates an architecture for using machine learning (ML) for optimization of management and scheduling of cleaning photovoltaic (PV) panels, according to some embodiments;

FIG. 2 illustrates an architecture details for a particle deposition (PD) detection sensor, according to some embodiments;

FIG. 3 illustrates a process for using ML for optimizing management and scheduling of cleaning PV panels, according to some embodiments; and

FIG. 4 illustrates an example computing environment utilized by some embodiments.

### DETAILED DESCRIPTION

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments relate to machine learning (ML) for optimizing management and scheduling of cleaning photovoltaic (PV) panels. One embodiment provides a method including dynamically measuring, by a computing device, dust level representing decay in transistor current output by utilizing at least one particle deposition (PD) detection sensor that utilizes ML for condition based PV panel cleaning. An ML-based edge process is utilized for managing a cleaning schedule and cleaning fleets. Yield is boosted and dynamic planning is improved based on multiple input sources for the ML-based edge process.

At first blush, one would think that cleaning PV panels regularly is the best solution. There are, however, a few problems associated with this approach, such as: anti-soiling coating may not have been available on prior installed panels and is still not widespread; the required vast land mass for a solar farm, hence few options while choosing a specific area; water based cleaning: water may be a scarce commodity; cleaning liquid: leaves a deposit on PV panels or modules; the associated cost of cleaning, etc. It is necessary to understand what the cleaning cycle time should be, as it is usually associated with a cost. It is a known fact that cleaning of a solar PV panel/module is important. While the power generated by a cleaned PV panel leads to increased revenue, the cost of cleaning may offset this revenue. Thus, it is important to define how often the cleaning cycle is required to generate the maximum revenue.

Current PV panel cleaning solutions only include a periodic cleaning based on a fixed formula regarding the climatic conditions. These formulas are common, and they are targeted to large geographic areas rather than specific areas where a solar plant is constructed. An example is a middle east country where it is recommended to have cleaning twice a week. While in other countries, such as India or the U.S., it is recommended to clean PV panels/modules bi-weekly.

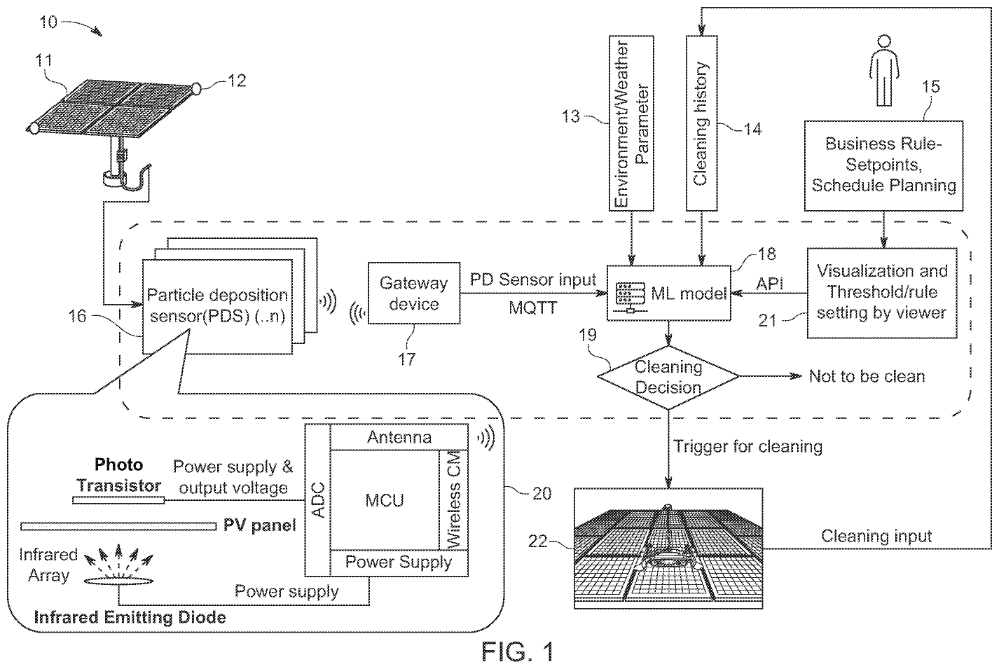

FIG. 1 illustrates an architecture 10 for using ML for optimization of management and scheduling of cleaning PV panels, according to some embodiments. One or more embodiments provide a condition based PV (or module) panel 11 cleaning system using one or more PD detection sensors 16 (with PD detection sensor architecture details 20) at position 12 (where a PD detection sensor 16 is disposed on each PV panel 11) with AI/ML framework. Some embodiments provide a direct method to sense dust deposition on the PV panel 11. The PD detection sensor 16 is deployed at a same position of the PV panel 11. The deployment of PD detection sensors 16 is based on racking groups with a same tilt and azimuth. The passive PD detection sensor 16 measures the dust level using architecture details 20, which represents decay in a transistor's current output. The data is sent to a nearby edge device/cloud (gateway device 17) from the PD detection sensor 16 that provides data (along with data from each PD detection sensor (in an array) for each PV panel 11 in the system architecture 10) to a process using at least one ML model 18 with reference to historical data (cleaning history 14) using message queuing telemetry transport (MQTT), one or more environment parameters (and/or weather parameters) 13 to determine the cleaning schedule (from business rule setpoints and schedule planning information 15) and to trigger the cleaning fleet 22 from the cleaning decision 19. The rule engine 21 is utilized to obtain a variable threshold value to trigger a wash cycle and factor to acceptable power loss to offset the cleaning cost.

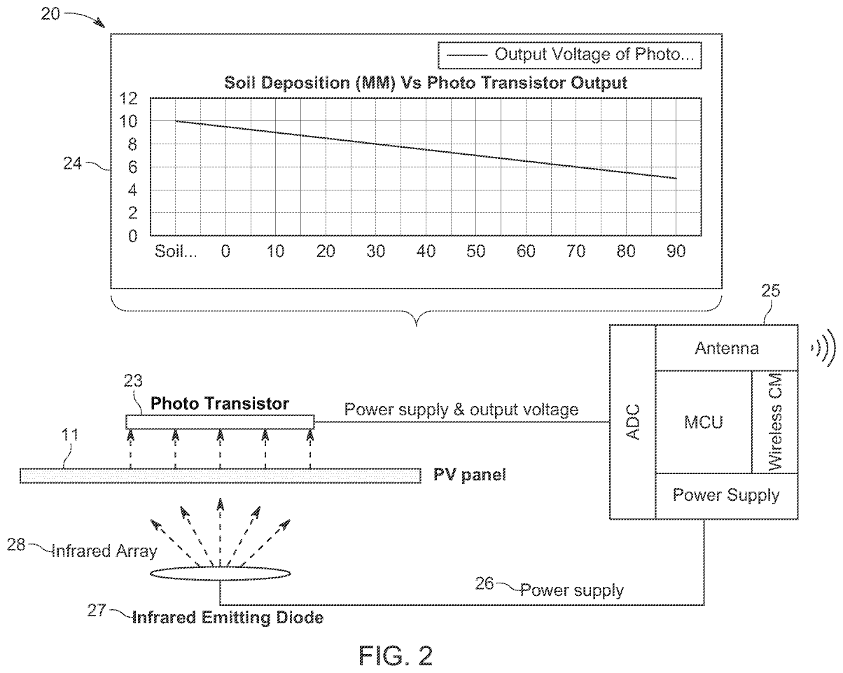

In some embodiments, the one or more PD detection sensors 16 architecture details 20 provide an accurate way to measure soiling by utilizing an infrared array 28 (FIG. 2) and photo transistor 23 (FIG. 2), voltage output from at least one transistor is inversely proportional to accumulated soil. Wireless technology (e.g., Long range (LoRa), WiFi, etc. for wireless connectivity) is utilized to transmit sensor values to a centralised gateway device 17 to accumulate all PD detection sensor 16 data of a solar array farm with management of data ingestion frequency to edge computation. In one or more embodiments, edge computation ingests data from the gateway device 17 to measure soiling information, environment parameter(s) 13 and cleaning history 14 of the PV panel 11 to an ML model 18 to predict and plan the cleaning schedule. The trigger is provided to a cleaning fleet 22 to optimize a cleaning path and process. The architecture 10 provides the environmental parameter(s) 13 that may include weather/environment forecasts such as wind, rainfall, temperature, humidity, dust density, etc., and also the cleaning history 14 to the ML model 18 engine for predicting and planning of a cleaning schedule. Human interaction with the system (visualization and threshold/rule setting by viewer 21) may be utilized to visualize a cleaning schedule and providing human input (from business rule setpoints and schedule planning information 15) to set business rules, such as setpoint adjustment for soiling threshold and adjusting a plan/scheduling. In some embodiments, the trigger from cleaning decision 19 based on the ML model 18 is provided to a cleaning fleet 22 to achieve an optimized path for cleaning. The cleaning input from the cleaning fleet 22 is stored/recorded with the cleaning history 14 to update the historical data.

In one or more embodiments, the PD detection sensor 16 is used to capture real information from the PV panel 11 using architecture details 20, and based on the ML model 18 to trigger the cleaning fleet 22. Distinguishable from the conventional techniques, some embodiments use an identification technique, which is based on measuring the PD detection sensor 16 value, which changes in proportion to soil deposition, and cleaning fleet management based on a cleaning trigger targeting the cleaning fleet 22 based on input received from the PD detection sensor 16, environment parameters 13 and cleaning history 14.

In one or more embodiments, the ML model(s) 18 or algorithms utilized employ one or more AI models or algorithms. AI models may include a trained ML model 18 (e.g., models, such as an NN, a CNN, a recurrent NN (RNN), a Long short-term memory (LSTM) based NN, gate recurrent unit (GRU) based RNN, tree-based CNN, KNN, a self-attention network (e.g., a NN that utilizes the attention mechanism as the basic building block; self-attention networks have been shown to be effective for sequence modeling tasks, while having no recurrence or convolutions), BILSTM (bi-directional LSTM), etc.). An artificial NN is an interconnected group of nodes or neurons.

FIG. 2 illustrates the architecture details 20 for the PD detection sensor 16, according to some embodiments. In one or more embodiments, the architecture details 20 includes an infrared emitting diode 27 that emits an infrared array 28 of light transfer through the PV Panel 11. A photo transistor 23 generates output inversely proportional to soil deposition (see graph 24). A device 25 converts an analog signal from the photo transistor 23 to a digital representation to process and transmit to the gateway device 17 (FIG. 1). A power supply 26 provides the power for the infrared emitting diode 27 for the infrared array 28. The wireless communication utilizes wireless technology (e.g., LoRa, WiFi, etc. for wireless connectivity). In some embodiments, the device 25 may include an analog-to-digital converter (ADC), an antenna, a microcontroller (MCU), a power supply, a wireless communication modem (CM), etc. In some embodiments, the benefits may include narrowing power loss due to soiling; improving solar throughput and company financial metrics; optimizing a cleaning fleet 22 (FIG. 1) by changing periodic based cleaning to condition based cleaning; improving operational efficiency and reducing operational costs; and improving return on investment (ROI) in highly capital intensive solar farming businesses.

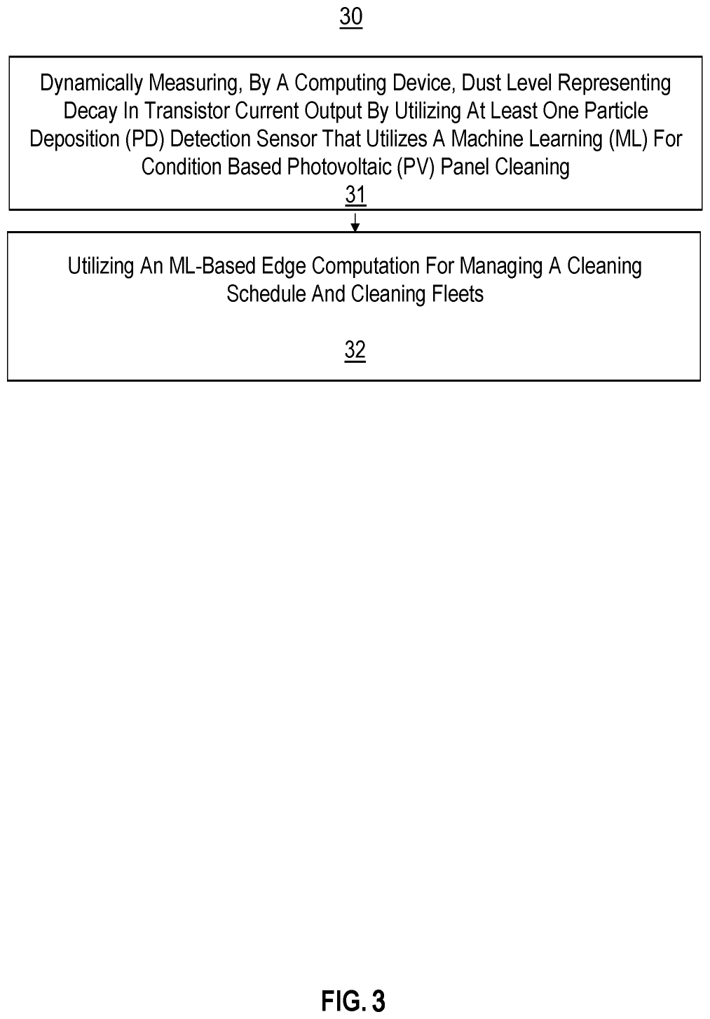

FIG. 3 illustrates a process 30 for using ML for optimizing management and scheduling of cleaning PV panels, according to some embodiments. In one embodiment, in block 31 process 30 dynamically measures, by a computing device, dust level representing decay in transistor current output by utilizing at least one PD detection sensor 16 (FIG. 1) (using device architecture 20 (FIGS. 1-2)) with architecture 10 (FIG. 1) that utilizes ML (ML model 18, FIG. 1) for condition based PV panel 11 (FIGS. 1-2) cleaning. In block 32, process 30 provides utilizing an ML-based edge process for managing a cleaning schedule and cleaning fleets, where yield is boosted and dynamic planning is improved based on multiple input sources for the ML-based edge process. Therefore, process 30 provides for dynamically measuring dust level, which represents decay in transistor current output, by using a passive PD detection sensor 16 and then uses the measurements to dynamically optimize a cleaning fleet based on captured real-time soil loss information from the PV panel 11 using edge-based solution. Some embodiments have the advantage that an AI/ML framework provides for a condition based PV panel (or module) 11 cleaning using the particle PD detection sensor 16 via device architecture 20. Another advantage is that an edge-based real-time trigger for cleaning fleets is provided that optimizes cleaning routes, boost or enhances system yield and reduces superfluous cleaning's useless effort and expense.

In some embodiments, process 30 may include the feature of dynamically deploying the at least one PD detection sensor based on racking groups with a same tilt and azimuth on a particular PV panel.

In one or more embodiments, process 30 may further include the feature that the multiple input sources are selected from the group consisting of soiling condition, particle deposition, environment condition and asset information.

In some embodiments, process 30 may include the feature where the at least one PD detection sensor is deployed at a same position of the PV panel.

In one or more embodiments, process 30 may additionally include the feature that the at least one PD detection sensor utilizes a passive particle deposition detection for measuring dust level that represents decay in transistor current output for the PV panel.

In some embodiments, process 30 may further include the feature that data from the at least one PD detection sensor is sent to an edge device for processing using an ML model with reference to historical data.

In one or more embodiments, process 30 may include the feature that a rule engine obtains a variable threshold value for triggering a wash cycle and for factoring an acceptable power loss.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

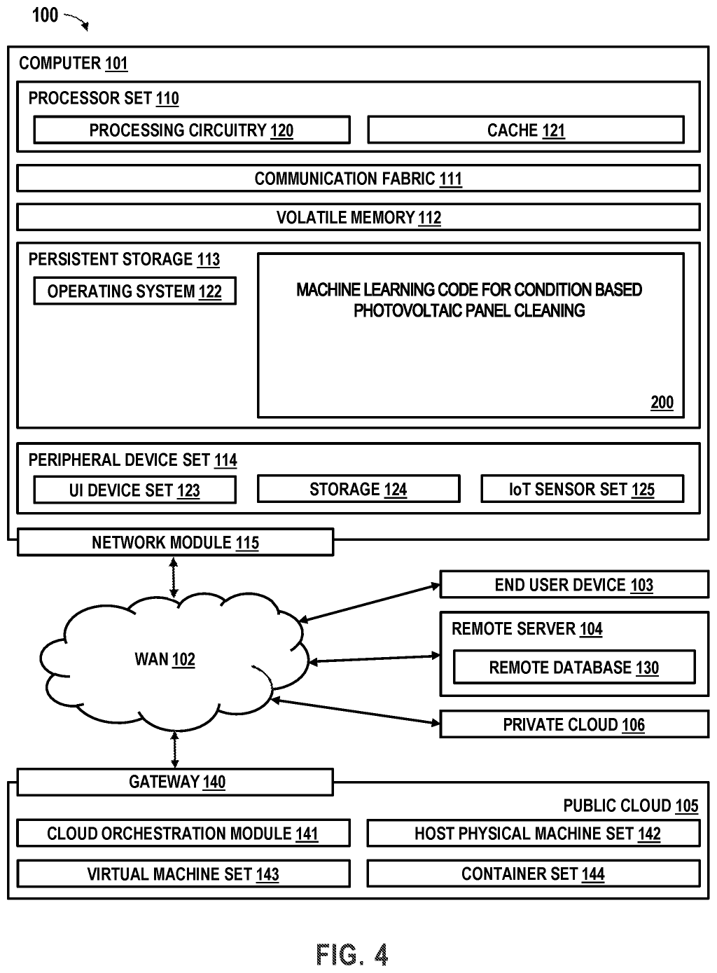

FIG. 4 illustrates an example computing environment 100 utilized by one or more embodiments. Computing environment 100 contains an example of an environment for the execution of at least some of the computer code 200 involved in performing the inventive methods (such as ML (model) code for condition based PV panel cleaning, etc.). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the embodiments for various embodiments with various modifications as are suited to the particular use contemplated.

What is claimed is:

1. A method comprising:
dynamically measuring, by a computing device, dust level representing decay in transistor current output by utilizing at least one particle deposition (PD) detection sensor that utilizes machine learning (ML) for condition based photovoltaic (PV) panel cleaning; and
utilizing an ML-based edge process for managing a cleaning schedule and cleaning fleets, wherein yield is boosted and dynamic planning is improved based on a plurality of input sources for the ML-based edge process.

2. The method of claim 1, further comprising:
dynamically deploying the at least one PD detection sensor based on racking groups with a same tilt and azimuth on a particular PV panel.

3. The method of claim 1, wherein the plurality of input sources is selected from the group consisting of soiling condition, particle deposition, environment condition and asset information.

4. The method of claim 1, wherein the at least one PD detection sensor is deployed at a same position of the PV panel.

5. The method of claim 1, wherein the at least one PD detection sensor utilizes a passive particle deposition detection for measuring dust level that represents decay in transistor current output for the PV panel.

6. The method of claim 1, wherein data from the at least one PD detection sensor is sent to an edge device for processing using an ML model with reference to historical data.

7. The method of claim 1, wherein a rule engine obtains a variable threshold value for triggering a wash cycle and for factoring an acceptable power loss.

8. A computer program product for utilizing machine learning (ML) for cleaning photovoltaic (PV) panels, the computer program product comprising a computer readable storage medium having program instructions embodied therewith, the program instructions executable by a processor to cause the processor to:
dynamically measure, by the processor, dust level representing decay in transistor current output by utilizing at least one particle deposition (PD) detection sensor that utilizes ML for condition based PV panel cleaning; and
utilize an ML-based edge process for managing a cleaning schedule and cleaning fleets, wherein yield is boosted and dynamic planning is improved based on a plurality of input sources for the ML-based edge process.

9. The computer program product of claim 8, wherein the program instructions executable by the processor to further cause the processor to:
dynamically deploy the at least one PD detection sensor based on racking groups with a same tilt and azimuth on a particular PV panel.

10. The computer program product of claim 8, wherein the plurality of input sources is selected from the group consisting of soiling condition, particle deposition, environment condition and asset information.

11. The computer program product of claim 8, wherein the at least one PD detection sensor is deployed at a same position of the PV panel.

12. The computer program product of claim 8, wherein the at least one PD detection sensor utilizes a passive particle deposition detection for measuring dust level that represents decay in transistor current output for the PV panel.

13. The computer program product of claim 8, wherein data from the at least one PD detection sensor is sent to an edge device for processing using an ML model with reference to historical data.

14. The computer program product of claim 8, wherein a rule engine obtains a variable threshold value for triggering a wash cycle and for factoring an acceptable power loss.

15. An apparatus comprising:
a memory configured to store instructions; and
a processor configured to execute the instructions to:
dynamically measure dust level representing decay in transistor current output by utilizing at least one particle deposition (PD) detection sensor that utilizes ML for condition based PV panel cleaning; and
utilize an ML-based edge process for managing a cleaning schedule and cleaning fleets, wherein yield is boosted and dynamic planning is improved based on a plurality of input sources for the ML-based edge process.

16. The apparatus of claim 15, wherein the processor is further configured to execute the instructions to:
dynamically deploy the at least one PD detection sensor based on racking groups with a same tilt and azimuth on a particular PV panel.

17. The apparatus of claim 15, wherein the plurality of input sources is selected from the group consisting of soiling condition, particle deposition, environment condition and asset information, and the at least one PD detection sensor is deployed at a same position of the PV panel.

18. The apparatus of claim 15, wherein the at least one PD detection sensor utilizes a passive particle deposition detection for measuring dust level that represents decay in transistor current output for the PV panel.

19. The apparatus of claim 15, wherein data from the at least one PD detection sensor is sent to an edge device for processing using an ML model with reference to historical data.

20. The apparatus of claim 15, wherein a rule engine obtains a variable threshold value for triggering a wash cycle and for factoring an acceptable power loss.
